(19) United States
(12) Patent Application Publication
(10) Pub. No.: US 2022/0103573 A1
(43) Pub. Date: Mar. 31, 2022

(54) INSPECTING NETWORK TRAFFIC ENCRYPTED WITH FORWARD SECRECY

(71) Applicant: Francisco Corella, Sacramento, CA (US)

(72) Inventor: Francisco Corella, Sacramento, CA (US)

(73) Assignee: Pomian & Corella LLC, Sacramento, CA (US)

(21) Appl. No.: 17/485,492

(22) Filed: Sep. 26, 2021

Related U.S. Application Data
(60) Provisional application No. 63/160,867, filed on Mar. 14, 2021.
(60) Provisional application No. 63/143,943, filed on Jan. 31, 2021.
(60) Provisional application No. 63/135,112, filed on Jan. 8, 2021.
(60) Provisional application No. 63/114,534, filed on Nov. 17, 2020.
(60) Provisional application No. 63/105,455, filed on Oct. 26, 2020.
(60) Provisional application No. 63/084,012, filed on Sep. 28, 2020.
(60) Provisional application No. 63/083,128, filed on Sep. 25, 2020.

(51) Int. Cl. H04L 29/06; H04L 9/08

(52) U.S. Cl. CPC H04L 63/1408; H04L 9/085; H04L 63/10; H04L 9/0891; H04L 9/0861

(57) ABSTRACT

A method is provided for inspecting network traffic carried by a connection that is encrypted as specified by a network encryption protocol that provides forward secrecy. A server establishes a shared secret with a client as specified by the protocol, derives traffic secrets from the shared secret, and sends the traffic secret to a visibility middlebox. The visibility middlebox derives keying materials from the traffic secrets and uses the keying materials to decrypt the traffic.

### CROSS-REFERENCE TO RELATED APPLICATIONS

The present application claims the benefit of provisional patent applications No. 63/160,867 (filed on Mar. 14, 2021), No. 63/143,943 (filed on Jan. 31, 2021), No. 63/135,112 (filed on Jan. 8, 2021), No. 63/114,534 (filed on Nov. 17, 2020), No. 63/105,455 (filed on Oct. 26, 2020), No. 63/084,012 (file on Sep. 28, 2020) and No. 63/083,128 (filed on Sep. 25, 2020), all of which are incorporated herein by reference.

### BACKGROUND

The current cyberthreat landscape presents enterprises with conflicting requirements in their datacenters. On one hand, they must encrypt their internal networks and provide end-to-end communication security between endpoints. On the other hand, they must be able to inspect internal network traffic for reasons including application health monitoring, troubleshooting, compliance audits, detection and mitigation of denial-of-service attacks, intrusion detection, and intrusion prevention.

These conflicting requirements have traditionally been addressed by using a network encryption protocol to encrypt traffic and providing network appliances known as “visibility middleboxes”, with means to decrypt the traffic. For example, a client computer (hereinafter, a “client”) may initiate a secure connection to a server computer (hereinafter, a “server”) that uses a static RSA key pair for authentication and key exchange. Connection traffic is encrypted under symmetric keys computed (or, synonymously, “derived”) from a secret that the client sends to the server encrypted under the RSA public key. A visibility middlebox can be provisioned with the RSA private key, so that it can decrypt the secret, derive the symmetric keys, and decrypt the traffic.

But the need to increase security in the current threat landscape has led to the use of network encryption protocols that encrypt traffic with forward secrecy, which is achieved using Diffie-Hellman (DH) or Elliptic-Curve Diffie-Hellman (ECDH) key exchange with ephemeral rather than static key pairs. (“Ephemeral ECDH” is traditionally abbreviated “ECDHE” and “Ephemeral DH or ECDH” is traditionally abbreviated “(EC)DHE”.) Since a fresh ephemeral key pair is generated for each connection, the private key component of that key pair cannot be provisioned to a visibility middlebox. Better methods of inspecting encrypted traffic in enterprise networks are therefore needed.

### SUMMARY

In one embodiment a server establishes a protocol shared secret with a client as specified by a network encryption protocol that encrypts traffic with forward secrecy. The server derives 0-RTT, handshake and application traffic secrets for each direction of traffic from the protocol shared secret, and sends the traffic secrets to a visibility middlebox. The visibility middlebox derives keying materials from the traffic secrets and uses the keying materials to decrypt the application traffic.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. Reference numerals consist of a concatenation of a one- or two-digit number referring to a figure, followed by a two-digit number that locates the referenced part within the figure. A reference numeral introduced in a figure may be used in other figures to refer to the same part or a similar part.

FIG. 1 is a block diagram of a system for inspecting network traffic encrypted with forward secrecy in an enterprise data center.

FIG. 2 is a flow diagram illustrating a process performed by a server to enable a visibility middlebox to inspect encrypted traffic.

FIG. 3 is a flow diagram illustrating a process performed by a visibility middlebox to inspect encrypted traffic.

FIG. 4 is a flow diagram illustrating an operating system process launched by a visibility middlebox for decrypting client-to-server traffic.

FIG. 5 is a flow diagram illustrating an operating system process launched by a visibility middlebox for decrypting server-to-client traffic.

### DETAILED DESCRIPTION

This Detailed Description refers to the accompanying drawings, which are a part hereof and illustrate examples of embodiments of the invention. It is to be understood that other embodiments are possible, and that the features of different exemplary embodiments can be combined together unless otherwise stated.

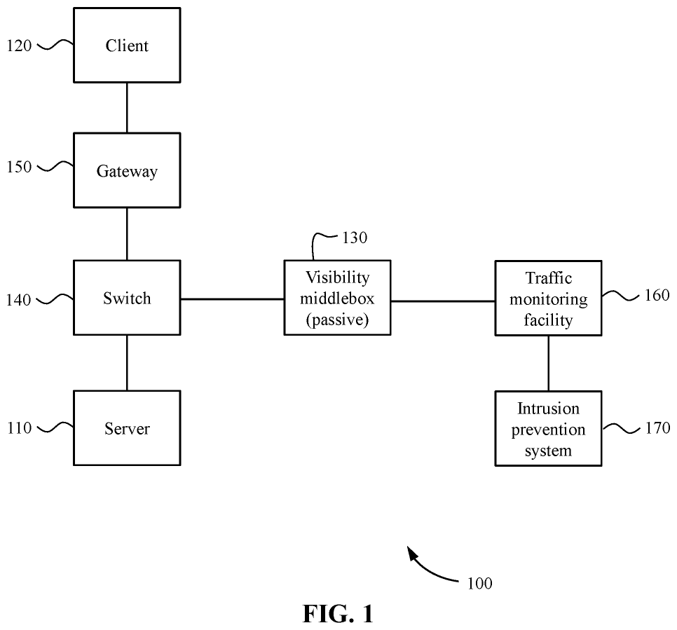

FIG. 1 is a block diagram illustrating a system 100 for inspecting network traffic encrypted with forward secrecy in an enterprise data center, according to some embodiments. The system comprises a server 110, which is the target endpoint of a secure connection initiated by a client 120 (hereinafter “the client-server connection”), and a visibility middlebox 130, which observes and decrypts the network traffic carried by the connection. The term “middlebox” as used herein should not be taken to imply that the visibility middlebox terminates and decrypts the connection, then reencrypts the traffic and relays the connection to the server. In a preferred embodiment, the visibility middlebox is a passive appliance that observes the traffic without modifying it in any way. In some embodiments network traffic is mirrored to the visibility middlebox by a switch 140 located in the network path between client and server. In other embodiments it is mirrored by some other kind of network equipment such as a router, a gateway, or the server itself. In yet other embodiments the visibility middlebox is integrated with a network appliance such as a switch, a router or a gateway, so that the traffic flows through the visibility middlebox, without being modified, instead of being mirrored to it.

Instead of being configured with static information such as a static RSA private key, the visibility middlebox receives from the server ephemeral information specific to the client-server connection. In some embodiments the information is transmitted from the server to the middlebox over a transport connection (hereinafter “the server-middlebox connection”) such as a long-standing Transmission Control Protocol (TCP) connection.

In some embodiments the network path from the client to the server goes through a gateway computer 150 (hereinafter “the gateway”) located at the boundary of the internal network of the datacenter, the client being located outside the internal network while the server is inside. The gateway, however, does not decrypt and reencrypt the client-server connection; it forwards encrypted connection traffic “as is” between client and server, so that the client-server connection is encrypted end-to-end. In alternative embodiments, client and server are both located in the internal network and there is no gateway in the network path between them.

In some embodiments the visibility middlebox forwards the decrypted connection traffic to a monitoring facility 160 that inspects it for purposes such as application health monitoring, troubleshooting, compliance audits, detection and mitigation of denial-of-service attacks and intrusion detection. In alternative embodiments the visibility middlebox inspects the decrypted connection traffic itself rather than forwarding it to a separate monitoring facility.

In some embodiments the visibility middlebox sends a decryption failure alert to an intrusion prevention system 170 when it is unable to decrypt a portion of the client-to-server traffic, which may be a sign that an attacker-controlled client is encrypting traffic with an attacker-generated key to avoid detection. Upon receiving the alert, the intrusion prevention system instructs the gateway 150 to block further client-originated traffic.

In some embodiments the client-server connection is encrypted as specified by a network encryption protocol that provides forward secrecy in some configurations, such as version 1.3 of Transport Layer Security (TLS) (hereinafter “TLS 1.3”), described in the Internet Engineering Task Force (IETF) Request For Comments (RFC) 8446, or version 1.2 of TLS (hereinafter “TLS 1.2”), described in RFC 5246. TLS 1.3 provides forward secrecy when used in two of the three modes of operation described in the preamble of Section 2 of RFC 8446, “(EC)DHE” and “PSK with (EC)DHE”, where “PSK” stands for “pre-shared key”. TLS 1.2 provides forward secrecy when configured to be used with a cipher suite that uses ECDHE for key exchange, such as, for example, TLS_ECDHE_ECDSA_WITH_ABS_128_GCM_SHA256.

Some network encryption protocols, such as TLS, use an initial exchange of messages, known as a “handshake”, to set up an encrypted connection between a client and a server. The client and server endpoints of the connection use the handshake to establish a shared secret (hereinafter, “the protocol shared secret”) and compute cryptographic elements from the shared secret such as symmetric keys and initialization vectors (hereinafter, “keying materials”) that are used to encrypt and decrypt connection traffic. Forward secrecy is achieved by using a cryptographic primitive such as DH or ECDH to compute the protocol shared secret from ephemeral key pairs. The server computes the protocol shared secret from its DH or ECDH private key and the client's public key while the client computes it from its own private key and the server's public key. Some network encryption protocols set up bidirectional connections using different sets of keying materials for client-to-server traffic and server-to-client traffic.

In some network encryption protocols, such as TLS 1.3, the computation of keying materials from the protocol shared secret proceeds in two stages. First, intermediate secrets, known as “traffic secrets”, are derived from the protocol shared secret. Then keying materials are derived from the traffic secrets. In TLS 1.3 some of the traffic secrets can be updated after the connection has been established, and updated keying materials can be derived from the updated traffic secrets, as described in Section 4.6.3 of RFC 8446.

In some network encryption protocols, such as TLS 1.2, messages exchanged during the handshake are sent in the clear, while in some other protocols, such as TLS 1.3, some handshake messages are sent encrypted under handshake keying materials that are different from the application keying materials used to encrypt application data, and are derived from handshake traffic secrets different from the application traffic secrets used in the derivation of the application keying materials.

More specifically, in TLS 1.3, handshake and application traffic secrets are derived from the protocol shared secret as described Section 7.1 of RFC 8446 and sets of handshake and application keying materials are computed from those traffic secrets as described in Section 7.3. There is one handshake traffic secret called “client_handshake_traffic_secret” for the client-to-server direction of traffic, and another called “server_handshake_traffic_secret” for the server-to-client direction of traffic. A set of handshake keying materials is computed from the client_handshake_traffic_secret, comprising a “client_write_key” and a “client_write_iv”, the client_write_iv being used to compute per-record nonces for Authenticated Encryption with Associated Data (AEAD) encryption as described in Section 5.3 of RFC 8446. Another set of handshake keying materials is similarly computed from the server_handshake_traffic_secret, comprising a “server_write_key” and a “server_write_iv”. There is an initial application traffic secret called “client_application_traffic_secret_0” for the client-to-server direction of traffic, that can be updated to traffic secrets called “client_application_traffic_secret_1”, “client_application_traffic_secret_2”, etc., as described in Section 7.2 of RFC 8446, and an initial application traffic secret called “server_application_traffic_secret_0” for the server-to-client direction of traffic that can similarly be updated. The set of keying materials derived from each of the application traffic secrets, as from each of the handshake traffic secrets, consists of a client_write_key and a client_write_iv for the client-to-server direction of traffic, and a server_write_key and a server_write_iv for the server-to-client direction of traffic.

In some network encryption protocols, such as TLS 1.3, the client and the server may share a PSK before the client initiates the connection. The client may then send traffic to the server, encrypted with keying materials computed from the PSK, immediately after its first message, before waiting for the server to send its first handshake message. Such traffic is known as “early data” or “zero-roundtrip traffic (0-RTT)” and a set of keying materials for encrypting and decrypting 0-RTT data is derived from a 0-RTT traffic secret, which is itself derived from the protocol shared secret.

The PSK may also be used as an input to the computation of the handshake and application traffic secrets, instead of, or in addition to, the protocol shared secret. When both the PSK and the protocol shared secret are used as inputs to that computation, handshake traffic and application traffic are encrypted with forward secrecy if the protocol shared secret is established using a DH or ECDH key exchange with ephemeral key pairs.

Some network encryption protocols, such as TLS 1.3, allow the server to ignore 0-RTT data without attempting to decrypt it, thus avoiding the risk of replay discussed in Section 8 of RFC 8446. However, this introduces the risk that an attacker-controlled client may use 0-RTT data to communicate with a compromised network appliance situated in the network path, encrypting the data under a key known only to the attacker to avoid detection. In some embodiments the visibility middlebox mitigates this risk by alerting the intrusion prevention system 170 of a failure to decrypt traffic that may have been caused by such an attack. The intrusion prevention system 170 can then instruct the gateway 150 to block further client-originated traffic.

In some embodiments the server and the visibility middlebox are provisioned with a symmetric key (hereinafter, “the visibility authentication key”) that they use to authenticate messages exchanged over the server-middlebox connection, by signing them with a symmetric signature primitive such as Hash-based Message Authentication Code (HMAC), specified in RFC 2104. Authenticated messages are used to establish an ephemeral shared secret between the server and the visibility middlebox (hereinafter, “the visibility shared secret”), which is then used to derive keying materials (hereinafter, “the visibility keying materials”) for encrypting further messages with forward secrecy before authenticating them. The server uses those encrypted messages to transmit the traffic secrets to the visibility middlebox, and the visibility middlebox uses the traffic secrets to derive keying materials and decrypt the connection traffic.

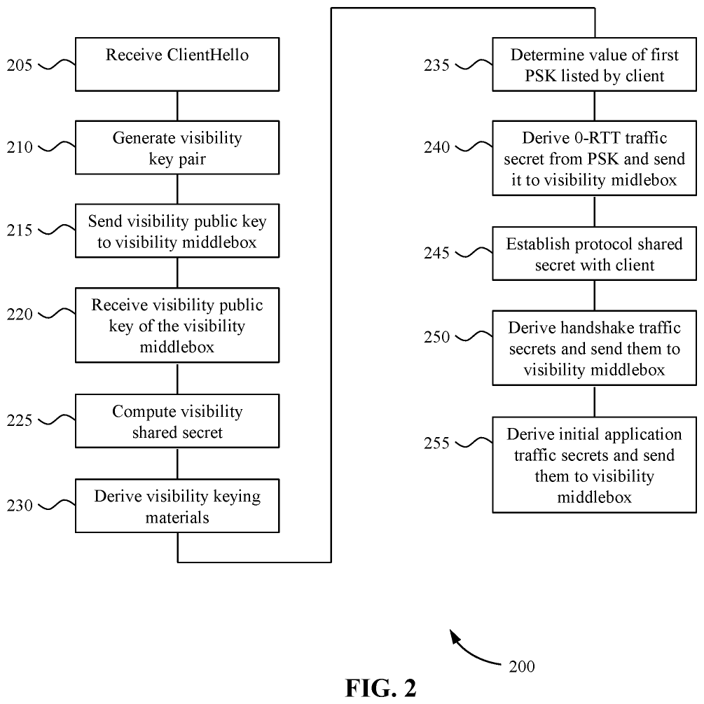

FIG. 2 is a flow diagram illustrating a process 200 performed by the server 110 to enable the visibility middlebox 130 to inspect the encrypted traffic carried by the client-server connection, according to some embodiments where the network encryption protocol is TLS 1.3 running over TCP and the server sends the traffic secrets to the visibility middlebox encrypted by an AEAD algorithm (hereinafter, “the visibility AEAD algorithm”).

At 205 the server 110 receives a ClientHello message from the client 120 and creates a record in memory, or in a file, or in a database (the server's “connection record”), associated with the TLS connection that the client is initiating. The record is retrievable by the connection ID of the underlying TCP connection, which comprises the IP address and TCP port of the source and destination of the connection. It should be understood hereinafter that the server stores data related to the connection in the connection record and retrieves it as needed by using the connection ID to access the record, even if this is not explicitly mentioned. Then the process continues at 210.

At 210 the server generates an ephemeral key pair, such as a DH or ECDH key pair (hereinafter, the “visibility key pair” of the server, comprising a “visibility private key” and a “visibility public key”) to be used for establishing the visibility shared secret with the visibility middlebox. The visibility middlebox similarly computes its own visibility key pair comprising its visibility private and public keys at step 310 of process 300 as described below. Then the process continues at 215.

At 215 the server sends a message to the visibility middlebox containing the connection ID and its visibility public key. Then the process continues at 220.

At 220 the server receives from the visibility middlebox a message containing the connection ID and the visibility public key of the visibility middlebox. Then the process continues at 225.

At 225 the server computes the visibility shared secret from the visibility public key of the visibility middlebox and its own visibility private key. Then the process continues at 230.

At 230 the server derives the visibility keying materials from the visibility shared secret, comprising an encryption key (the “visibility encryption key”) and three nonces (the “visibility nonces”), derived using the HMAC-based Key Derivation Function (HKDF) of RFC 5869 with the visibility shared secret as the “input keying material” and four different “info” values for the visibility encryption and the three visibility nonces. Then the process continues at 235.

At 235 the server determines the value of the first PSK listed by the client in the ClientHello message, which the client will use to protect 0-RTT data if the client does send 0-RTT data. Then the process continues at 240.

At 240 the server derives the 0-RTT traffic secret from the PSK as specified in Section 7.1 of RFC 8446, and sends it to the visibility middlebox, in a message that also contains the connection ID. The message is encrypted by the visibility AEAD algorithm using the visibility encryption key and the first of the three nonces derived from the visibility shared secret. The connection ID is sent in the clear as the associated data of the encrypted message. TLS 1.3 allows the server to reject the 0-RTT data without decrypting it, but the server computes the 0-RTT traffic secret nevertheless, so that it can send it the visibility middlebox, thus enabling the visibility middlebox to decrypt and inspect the 0-RTT data, or to alert the intrusion prevention system 170 if the 0-RTT data cannot be decrypted. Then the process continues at 245.

At 245 the server establishes the protocol shared secret with the client in the course of the TLS handshake as specified by RFC 8446. Then the process continues at 250.

At 250 the server derives the handshake traffic secrets for the client-to-server and server-to-client directions of traffic from the PSK and the protocol shared secret as specified in Section 7.1 of RFC 8446 and sends them to the visibility middlebox encrypted by the visibility AEAD algorithm using the visibility encryption key and the second of the three nonces derived from the visibility shared secret, with the connection ID as associated data. Then the process continues at 255.

At 255 the server derives the initial application traffic secrets for the client-to-server and server-to-client directions of traffic from the PSK and the protocol shared secret as specified in Section 7.1 of RFC 8446 and sends them to the visibility middlebox encrypted by the visibility AEAD algorithm using the visibility encryption key and the third of the three nonces derived from the visibility shared secret, with the connection ID as associated data. Then process 200 terminates.

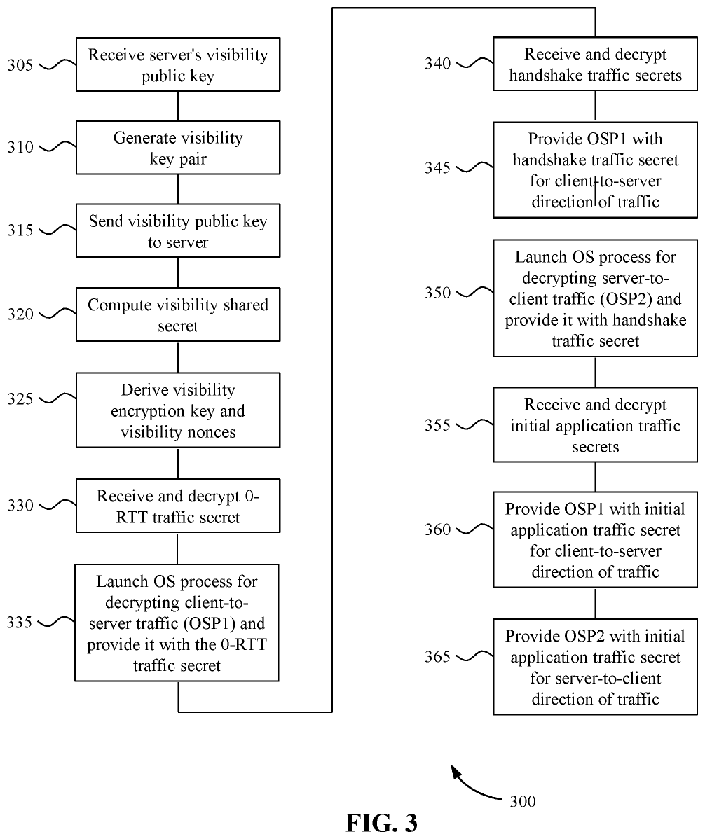

FIG. 3 is a flow diagram illustrating a process 300 performed by the visibility middlebox 130 to inspect the encrypted traffic carried by the client-server connection, according to the same embodiments illustrated in FIG. 2, where the network encryption protocol is TLS 1.3 running over TCP and the server 110 sends traffic secrets to the visibility middlebox encrypted by the visibility AEAD algorithm.

At 305 the visibility middlebox receives the message containing the connection ID and the server's visibility public key that the server sends at step 215 of process 200. Like the server, the visibility middlebox creates its own connection record retrievable by the connection ID, where it stores data related to the connection, including the server's public key received at 305. Then process 300 continues at 310.

At 310 the visibility middlebox generates its visibility key pair. Then process 300 continues at 315.

At 315 the visibility middlebox sends the connection ID and its visibility public key to the server. Then process 300 continues at 320.

At 320 the visibility middlebox computes the visibility shared secret from its visibility private key and the visibility public key of the server. Then process 300 continues at 325.

At 325 the visibility middlebox derives the visibility encryption key and the three visibility nonces. Then process 300 continues at 330.

At 330 the visibility middlebox receives the message containing the 0-RTT traffic secret sent by the server at step 240 of process 200, uses the connection ID sent in the clear as associated data to retrieve the connection record, and uses the visibility public key and the first visibility nonce found in the record to decrypt the message. Then process 300 continues at 335.

At 335 the visibility middlebox launches an operating system process to be used for decrypting the client-to-server connection traffic, hereinafter referred to as “Operating System Process 1 (OSP1)”, and provides it with the connection ID and the 0-RTT traffic secret. Then process 300 continues at 340.

At 340 the visibility middlebox receives the message containing the handshake traffic secrets sent by the server at step 250 of process 200, uses the connection ID to retrieve the connection record, and uses the visibility public key and the second visibility nonce found in the record to decrypt the message. Then process 300 continues at 345.

At 345 the visibility middlebox provides OSP1 with the handshake traffic secret for the client-to-server direction of traffic. Then process 300 continues at 350.

At 350 the visibility middlebox launches an operating system process to be used for decrypting server-to-client connection traffic, hereinafter referred to as “Operating System Process 2 (OSP2)”, and provides it with the connection ID and the handshake traffic secret for the server-to-client direction of traffic. Then process 300 continues at 355.

At 355 the visibility middlebox receives the message containing the initial application traffic secrets sent by the server at step 255 of process 200, uses the connection ID to retrieve the connection record, and uses the visibility public key and the third visibility nonce to decrypt the message. Then process 300 continues at 360

At 360 the visibility middlebox provides OSP1 with the initial application traffic secret for the client-to-server direction of traffic. Then process 300 continues at 365.

At 365 the visibility middlebox provides OSP2 with the initial application traffic secret for the server-to-client direction of traffic. Then process 300 terminates.

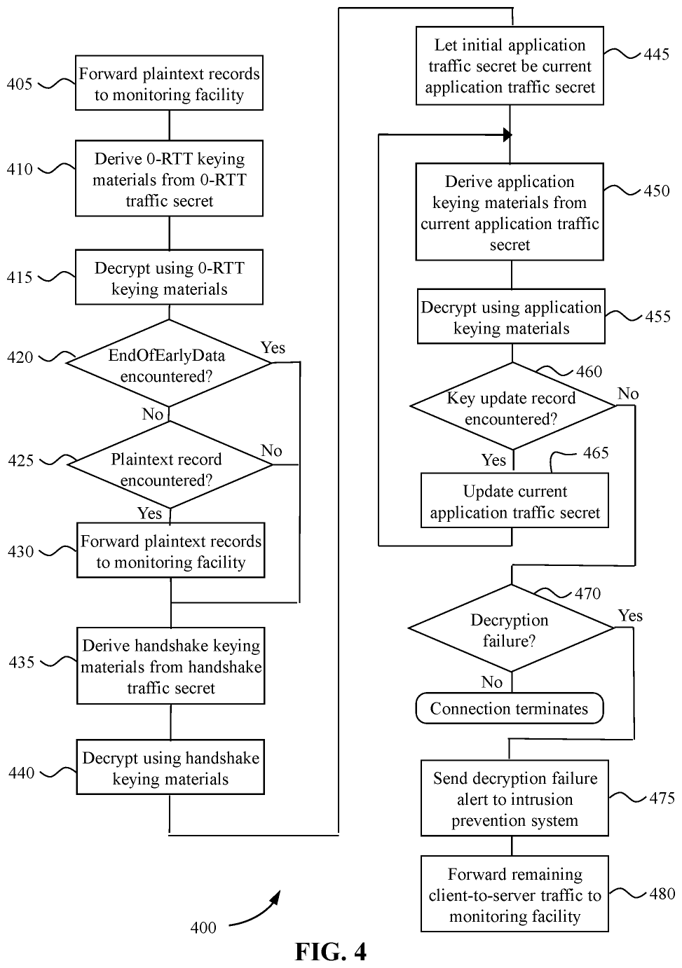

FIG. 4 is a flow diagram illustrating a process 400 performed by the OS process OSP1 for decrypting the client-to-server connection traffic launched by the visibility middlebox 130 at step 335 of process 300. OSP1 uses the connection ID that it is provided with when launched to identify the network traffic that pertains to the connection.

The client-to-server connection traffic begins with plaintext TLS records (whose ContentType is “handshake”) that carry the ClientHello message.

At 405 OSP1 forwards plaintext records to be inspected by the monitoring facility 160 until it encounters an encrypted record (whose ContentType is “application_data”; all encrypted records have ContentType “application_data”, regardless of the kind of plaintext they carry), which may be carrying 0-RTT data or handshake traffic. Then process 400 continues at 410.

At 410 OSP1 derives the set of 0-RTT keying materials from the 0-RTT traffic secret that it has been provided with when launched at step at step 335 of process 300. The derivation is performed as described in Section 7.3 of RFC 8446. Then process 400 continues at 415.

At 415 OSP1 decrypts zero or more records using the set of 0-RTT keying materials and forwards the decrypted records to be inspected by the monitoring facility 160, until it decrypts an EndOfEarlyData record, or it encounters a plaintext record (carrying the beginning of a second ClientHello following a HelloRetryRequest), or it encounters an encrypted record that cannot be decrypted with the set of 0-RTT keying materials (carrying handshake traffic that follows 0-RTT data or the initial ClientHello if there is no 0-RTT data). Then process 400 continues at 420.

At 420, if step 415 ended when an EndOfEarlyData record was decrypted, process 400 continues at 435; otherwise it continues at 425.

At 425, if step 415 ended when a plaintext record was encountered, process 400 continues at 430; otherwise it continues at 435.

At 430 OSP1 forwards plaintext records to be inspected by the monitoring facility 160 until it encounters an encrypted record. Then process 400 continues at 435.

At 435 OSP1 derives the set of keying materials for client-to-server handshake traffic from the client-to-server_handshake_traffic_secret that it has been provided with at step 345 of process 300. The derivation is performed as described in Section 7.3 of RFC 8446. Then process 400 continues at 440.

At 440 OSP1 decrypts records using the set of keying materials for client-to-server handshake traffic and forwards the decrypted records to be inspected by the monitoring facility 160, until it encounters an encrypted record that cannot be decrypted. Then process 400 continues at 445.

At 445 OSP1 sets the initial traffic secret for client-to-server application traffic that it has been provided with at step 360 of process 300 as the current traffic secret for client-to-server application traffic, from which updated such secrets may be later derived. Then process 400 continues at 450.

At 450 OSP1 derives a set of keying materials for client-to-server application traffic from the current application traffic secret for client-to-server traffic. The derivation is performed as described in Section 7.3 of RFC 8446. Then process 400 continues at 455.

At 455 OSP1 decrypts records using the set of keying materials for client-to-server application traffic and forwards the decrypted records to be inspected by the monitoring facility 160, until it decrypts a KeyUpdate record, or it encounters an encrypted record that cannot be decrypted, or the connection terminates. Then process 400 continues at 460.

At 460, if step 455 ended when a KeyUpdate record was decrypted, process 400 continues at 465; otherwise it continues at 470.

At 465, OSP1 updates the current application traffic secret for client-to-server traffic as described in Section 4.6.3 of RFC 8446. Then process 400 loops back to 450.

At 470, if step 455 ended when a record could not be decrypted, process 400 continues at 475. Otherwise step 455 ended when the connection terminated, and process 400 ends.

At 475, OSP1 causes the visibility middlebox to send a decryption failure alert to the intrusion prevention system 170, which then instructs the gateway 150 to block further traffic received from the client 120. Then process 400 continues at 480.

At 480, OSP1 forwards all remaining client-to-server traffic to the monitoring facility 160 without attempting to decrypt it, and process 400 ends when the connection ends.

It should be noted that a decryption failure encountered at 470 may be the result of a decryption failure encountered at 415 caused by 0-RTT data that an attacker has encrypted with a key known only to the attacker. Encountering an attacker-encrypted record at step 415 causes process 400 to flow through steps 420, 425 and 435 to step 440, where a second decryption failure is caused by the same record, which cannot be decrypted with the handshake keying materials. Process 400 then flows through steps 445 and 450 to step 455, where a third decryption failure is caused by the same record, which cannot be decrypted with the application keying materials.

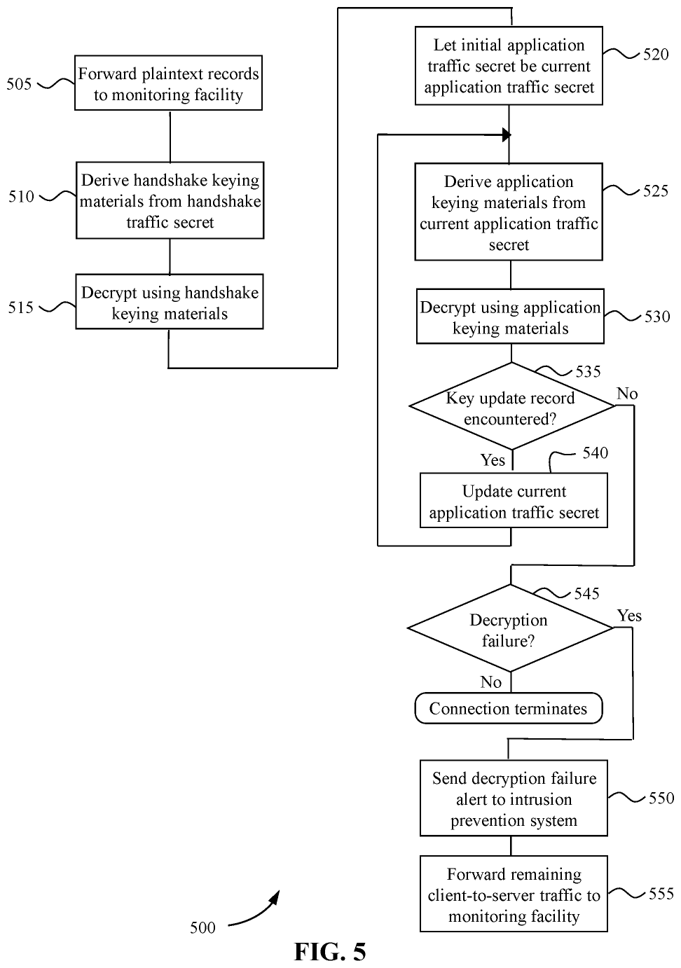

FIG. 5 is a flow diagram illustrating a process 500 performed by the OS process OSP2 for decrypting the server-to-client connection traffic launched by the visibility middlebox 130 at step 350 of process 300. OSP2 uses the connection ID that it is provided with when launched to identify the network traffic that pertains to the connection.

The server-to-client connection traffic begins with plaintext TLS records (whose ContentType is “handshake”) that carry the ServerHello message.

At 505 OSP2 forwards plaintext records to be inspected by the monitoring facility 160 until it encounters an encrypted record. Then process 500 continues at 510.

At 510 OSP2 derives the set of keying materials for server-to-client handshake traffic from the server-to-client_handshake_traffic_secret that it has been provided with when launched at step 350 of process 300. Then process 500 continues at 515.

At 515 OSP2 decrypts records using the set of keying materials for server-to-client handshake traffic and forwards the decrypted records to be inspected by the monitoring facility 160, until it encounters an encrypted record that cannot be decrypted. Then process 500 continues at 520.

At 520 OSP2 sets the initial traffic secret for server-to-client application traffic that it has been provided with at step 365 of process 300 as the current traffic secret for server-to-client application traffic, from which updated such secrets may be later derived. Then process 500 continues at 525.

At 525 OSP2 derives a set of keying materials for server-to-client application traffic from the current application traffic secret for server-to-client traffic. The derivation is performed as described in Section 7.3 of RFC 8446. Then process 500 continues at 530.

At 530 OSP2 decrypts records using the set of keying materials for server-to-client application traffic and forwards the decrypted records to be inspected by the monitoring facility 160, until it decrypts a KeyUpdate record, or it encounters an encrypted record that cannot be decrypted, or the connection terminates. Then process 500 continues at 535.

At 535, if step 530 ended when a KeyUpdate record was decrypted, process 500 continues at 540; otherwise it continues at 545.

At 540, OSP2 updates the current application traffic secret for server-to-client traffic as described in Section 4.6.3 of RFC 8446. Then process 500 loops back to 525.

At 545, if step 530 ended when a record could not be decrypted, process 500 continues at 550. Otherwise step 530 ended when the connection terminated, and process 500 ends.

At 550, OSP2 causes the visibility middlebox to send a decryption failure alert to the intrusion prevention system 170, which then instructs the gateway 150 to block further traffic received from the client 120. Then process 500 continues at 555.

At 555, OSP2 forwards all remaining server-to-client traffic to the monitoring facility 160 without attempting to decrypt it, then process 500 ends.

20. A method of inspecting network traffic carried by a connection that is encrypted as specified by a network encryption protocol, comprising:
a step, performed by a server, of establishing a protocol shared secret with a client;
a step, performed by the server, of deriving one or more application traffic secrets from the protocol shared secret;
a step, performed by the server, of sending a message containing the one or more application traffic secrets to a visibility middlebox that observes the network traffic, the message being encrypted using visibility keying materials derived from an ephemeral visibility shared secret established between the server and the visibility middlebox;
a step, performed by the visibility middlebox, of receiving the message containing the one or more application traffic secrets and decrypting it using the visibility keying materials;
a step, performed by the visibility middlebox, of deriving one or more sets of application keying materials from the one or more application traffic secrets; and
a step, performed by the visibility middlebox, of decrypting application traffic using the one or more sets of application keying materials.

2. The method of claim 1, wherein the visibility middlebox inspects the decrypted traffic.

3. The method of claim 1, wherein the visibility middlebox forwards decrypted traffic to a monitoring facility for inspection.

4. The method of claim 1 wherein the message containing the one or more application traffic secrets further contains a TCP connection ID that the visibility middlebox uses to identify the identify the network traffic that pertains to the connection.

5. The method of claim 1, wherein the one or more application traffic secrets comprise an application traffic secret pertaining to a client-to-server direction of traffic, and an application traffic secret pertaining to a server-to-client direction of traffic.

6. The method of claim 1, further comprising:
A step, performed by the server, of generating a visibility key pair comprising a visibility private key and a visibility public key;
a step, performed by the visibility middlebox, of generating a visibility key pair comprising a visibility private key and a visibility public key;
a step, performed by the server, of computing the ephemeral visibility shared secret from the visibility public key comprised in the visibility key pair generated by the visibility middlebox and the visibility private key comprised in the visibility key pair generated by the server; and
a step, performed by the visibility middlebox, of computing the ephemeral visibility shared secret from the visibility public key comprised in the visibility key pair generated by the server and the visibility private key comprised in the visibility key pair generated by the visibility middlebox.

7. The method of claim 1, further comprising steps performed by the visibility middlebox to effect a sequence of one or more key update procedures, each key update procedure comprising:
deriving an updated application traffic secret from an earlier application traffic secret;
deriving an updated set of application keying materials from the updated application traffic secret; and
decrypting application traffic using the updated set of application keying material.

8. The method of claim 1, wherein the network encryption protocol includes a handshake, the method further comprising:
a step, performed by the server, of computing one or more handshake traffic secrets from the protocol shared secret;
a step, performed by the server, of sending the one or more handshake traffic secrets to the visibility middlebox;
a step, performed by the visibility middlebox, of computing one or more sets of handshake keying materials from the one or more handshake traffic secrets; and
a step, performed by the visibility middlebox, of decrypting handshake traffic using the one or more sets of handshake keying materials.

9. The method of claim 1, wherein the computation of the one or more application traffic secrets from the protocol shared secret takes as a further input a key that has been pre-shared between the server and the client, the method further comprising:
a step, performed by the server, of computing a 0-RTT traffic secret from the pre-shared key;
a step, performed by the server, of sending the 0-RTT traffic secret to the visibility middlebox;
a step, performed by the visibility middlebox, of computing a set of 0-RTT keying materials from the 0-RTT traffic secret; and
a step, performed by the visibility middlebox, of attempting to decrypt 0-RTT data using the set of 0-RTT keying materials.

10. The method of claim 9, further comprising a step, performed by the visibility middlebox upon being unable to decrypt a portion of the traffic sent by the client, of sending a decryption failure alert to an intrusion prevention system configured to instruct a gateway to block further traffic received from the client.

11. A server configured to perform a method of inspecting network traffic carried by a connection that is encrypted as specified by a network encryption protocol, the method comprising:
establishing a protocol shared secret with a client;
deriving one or more application traffic secrets from the protocol shared secret; and
sending the one or more application traffic secrets to a visibility middlebox, the application traffic secrets being encrypted using visibility keying materials derived from an ephemeral visibility shared secret established between the server and the visibility middlebox, the visibility middlebox being configured to receive and decrypt the one or more application traffic secrets, derive one or more sets of application keying materials from the one or more application traffic secrets, and decrypt application traffic using the one or more sets of application keying materials.

12. The server of claim 11, wherein the server computes the ephemeral visibility shared secret from a visibility public key comprised in a visibility key pair generated by the visibility middlebox and a visibility private key comprised in a visibility key pair generated by the server.

13. The server of claim 11, wherein the method performed by the server further comprises:
establishing a visibility shared secret with the visibility middlebox;
deriving a set of visibility keying materials from the visibility shared secret; and
encrypting the one or more application traffic secrets using the set of visibility keying materials before sending them to the visibility middlebox.

14. The server of claim 11, wherein the network encryption protocol includes a handshake, the method performed by the server further comprising:
deriving one or more handshake traffic secrets from the protocol shared secret; and
sending the one or more handshake traffic secrets to the visibility middlebox, the visibility middlebox being further configured to derive one or more sets of handshake keying materials from the one or more handshake traffic secrets and decrypt handshake traffic using the one or more sets of handshake keying materials.

15. The server of claim 11, wherein the derivation of the one or more application traffic secrets from the protocol shared secret takes as a further input a key that has been pre-shared between the server and the client computer, the method further comprising:
deriving a 0-RTT traffic secret from the pre-shared key; and
sending the 0-RTT traffic secret to the visibility middlebox, the visibility middlebox being further configured to derive a set of 0-RTT keying materials from the 0-RTT traffic secret and attempt to decrypt 0-RTT data using the set of 0-RTT keying materials.

16. A visibility middlebox configured to perform a method of inspecting network traffic carried by a connection that is encrypted as specified by a network encryption protocol, the method comprising:
receiving a message containing one or more application traffic secrets from a server, the message being encrypted using visibility keying materials derived from an ephemeral visibility shared secret established between a server and the visibility middlebox;
deriving one or more sets of application keying materials from the one or more application traffic secrets; and
decrypting application traffic using the one or more sets of application keying materials.

17. The visibility middlebox of claim 16 wherein the message containing the one or more application traffic secrets further contains a TCP connection ID that the visibility middlebox uses to identify the connection.

18. The visibility middlebox of claim 16, wherein the visibility middlebox computes the ephemeral visibility shared secret from a visibility private key comprised in a visibility key pair generated by the visibility middlebox and a visibility public key comprised in a visibility key pair generated by the server.

19. The visibility middlebox of claim 16, wherein the method performed by the visibility middlebox further comprises steps performed to effect a sequence of one or more key update procedures, each key update procedure comprising:
deriving an updated application traffic secret from an earlier application traffic secret;
deriving an updated set of application keying materials from the updated application traffic secret; and
decrypting application traffic using the updated set of application keying materials.

20. The visibility middlebox of claim 16, wherein the method performed by the visibility middlebox further comprises:
computing a 0-RTT traffic secret from a key pre-shared between the server, a client computer, and the visibility middlebox;
computing a set of 0-RTT keying materials from the 0-RTT traffic secret;
attempting to decrypt 0-RTT traffic using the set of 0-RTT keying materials; and
alerting an intrusion prevention system of a failure to decrypt 0-RTT data using the set of 0-RTT keying materials.
